(19) United States
(12) Patent Application Publication
(10) Pub. No.: US 2005/0162410 A1
(43) Pub. Date: Jul. 28, 2005

(54) Touch sensitive display device

(75) Inventors: Mark Thomas Johnson, Eindhoven (NL); Galileo June Adeva Destura, Eindhoven (NL); Ronaldus Maria Aarts, Eindhoven (NL); Alan George Knapp, Pound Hill (GB); Simon Robert Marsh, Zandvoort (NL); Martinus Hermanus Wilhelmus Maria Van Delden, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/507,822

(22) PCT Filed: Feb. 14, 2003
(86) PCT No.: PCT/IB03/00627

(30) Foreign Application Priority Data
Mar. 15, 2002 (EP) 02251892.2

(51) Int. Cl. G09G 5/00

(52) U.S. Cl. 345/174

(57) ABSTRACT

In a touch sensor the change in pixel impedance is measured from the sensing area directly (passive matrix) or through the address transistors (AMLCD) associated with the sensing area.

The invention relates to a touch sensitive display device comprising a multiple of picture elements and means for driving at least one of said picture elements together with means for monitoring the impedance of at least one of said picture elements.

The display device is for instance a liquid crystal display device or a O(LED) display or a display based on electrochromic effects. For liquid crystal display devices the impedance of a picture element mainly consists of a capacitive element, whereas for electrochromic displays and O(LED) display devices, especially in reverse bias the impedance of a picture element mainly is resistive.

Such display devices have found widespread use in the computer industry and in handheld devices ranging from mobile telephones and price tags to palm top computers and organizers. Also the combination with a touching device such as a stylus has found widespread applications, while also a need for other ways of providing input via the display screen is felt.

U.S. Pat. No. 5,777,596 describes a touch sensitive liquid crystal display device that allows putting input into the associated device (e.g. a computer) by simply touching the display screen with a finger, a stylus or a pen. The device continuously compares the charge time of the liquid crystal display elements (picture elements) to a reference value and uses the result of the comparison to determine which elements are being touched.

One of the problems in said touch sensitive liquid crystal display device resides in restoring the right image after sensing. This is due to the fact that a blinking line is used which represents the switching of all picture elements in a row between two extreme states. When the blinking line reaches a certain row touching is detected by measuring the charging time of the picture elements. After measuring the picture elements are provided with adequate voltages to display the right image. In a similar way sensing by means of a blinking spot is disclosed in U.S. Pat. No. 5,777,596.

Such blinking however is visible on the display (artifacts).

Apart from using rather complex circuitry, in this way of sensing it is difficult to take into account the difference in liquid crystal display properties such as kick back which differs for writing odd or even frames. Moreover, if a reflective display device is used, internal DC bias voltages may be present whereby charging differs for writing odd or even frames. In DC-driving methods (low power liquid crystal displays, electrophoresis) no inversion occurs so the method cannot be used at all there.

The invention has among others as its goal to overcome these objections.

It has as a further goal to introduce more functionality into the touch sensitive liquid crystal display device.

To this end in a touch sensitive display device according to the invention provides the means for monitoring the impedance of at least one of said picture elements substantially and simultaneously sensing a change in said impedance. In fact the invention provides a method of non-interactive measuring; the method of measuring does not interfere with the providing of driving voltages to the picture elements.

This does not only overcome the problem of providing blinking signals but also offers new possibilities of touch sensing such as
i) sensing touch inputs at different places on the display screen
ii) disabling part of the display screen for touch sensing
   Both possibilities offer substantial advantages both in computer and telecommunication applications.

Sensing touch inputs substantially simultaneously at different places on the display screen offers possibilities such as detecting the impact of fingers or pencils on different places of the display screen. This is a useful item in e.g. flat screen (computer) devices in which the keyboard functions have been realized as touch functions on the screen. It is for example possible to detect simultaneous touching of CRTL, ALT and DEL pressing; similarly in e.g. drawing programs the simultaneous touching of two points with a pen may immediately display a straight line, while at the same time via a third touching (area) this line may receive a certain curvature or hatching etc. Further applications are e.g. gaming or features which enables either the user or a service provider or receiver of a service to enable and disable a part of the touch screen data input, e.g. obtained via the Internet may prevent certain parts (displaying logos) to be disturbed or disable certain menu bars for unauthorized users.

On the other hand disabling part of the display screen for touch sensing may be used in a cellular phone preventing the read out from being disturbed.

The sensing itself may be performed by measuring a change in voltage or a change in frequency.

The change in impedance within a single picture element, e.g. the pixel capacitance in a liquid crystal display device, generally is much smaller than the total capacitance of the other pixels (in a passive matrix display), or the total capacitance of crossovers and stray capacitances in the columns and rows (in an active matrix display). This reduces the sensitivity of a touch sensor. In an active matrix liquid crystal display (AMLCD) such a total capacitance is typically 10-100 times higher than the pixel capacitance—in a passive matrix display the factors are even higher.

One if the solutions according to the invention is to ensure that many pixels along the column (or row) are sensed at the same moment. In this case, the touch signal will increase with the number of pixels being sensed, whilst the background impedance will remain constant. In this way the signal to noise ratio increases.

To this end a first embodiment of a touch sensitive display device according to the invention provides means for monitoring the impedance (capacitance) of at least one row of picture elements, while in a second embodiment the means for monitoring impedance monitor at least the impedance (capacitance) of one column of picture elements. Also monitoring of the impedance of a block of picture elements is possible.

In a preferred embodiment of a touch sensitive display device the means for monitoring the impedance (capacitance) comprise means for comparing the impedance (capacitance) of the picture elements with a reference value.

Said reference value may be a fixed value but preferably is determined by impedance (capacitance) values of said picture elements having voltages outside the transition region of the liquid crystal picture elements. On the other hand it may be determined on a dynamic basis in which case the means for comparing the impedances (capacitances) comprise means to determine the reference value.

These and other aspects of the invention are apparent from and will be elucidated with reference to the embodiments described hereinafter.

In the drawings:

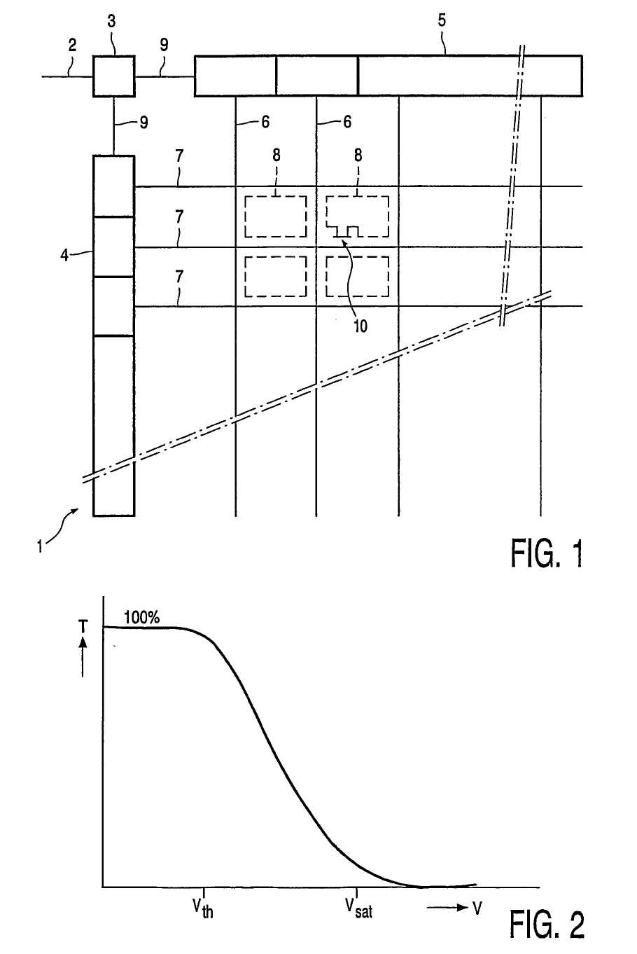

FIG. 1 schematically shows a liquid crystal device,

FIG. 2 shows a voltage transmission curve of a liquid crystal device,

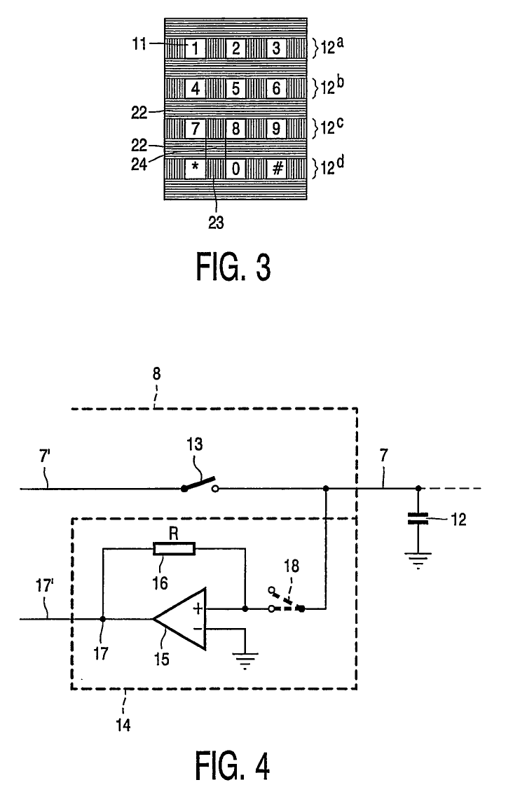

FIG. 3 shows a first embodiment of a part of a touch sensitive liquid crystal device according to the invention, while

FIGS. 4, 5 and 6 show further embodiments of a part of a touch sensitive liquid crystal device according to the invention. The Figures are diagrammatic and not drawn to scale. Corresponding elements are generally denoted by the same reference numerals.

FIG. 1 is an electric equivalent circuit diagram of a part of a display device 1 to which the invention is applicable. It comprises in one mode of driving, called the “passive mode”, a matrix of pixels 8 defined by the areas of crossings of row or selection electrodes 7 and column or data electrodes 6. The row electrodes are consecutively selected by means of a row driver 4, while the column electrodes are provided with data via a data register 5. To this end, incoming data 2 are first processed, if necessary, in a processor 3. Mutual synchronization between the row driver 4 and the data register 5 takes place via drive lines 9.

In another mode of driving, called the “active mode”, signals from the row driver 4 select the picture electrodes via thin-film transistors (TFTs) 10 whose gate electrodes are electrically connected to the row electrodes 7 and the source electrodes are electrically connected to the column electrodes. The signal which is present at the column electrode 6 is transferred via the TFT to a picture electrode of a pixel 8 coupled to the drain electrode. The other picture electrodes are connected to, for example, one (or more) common counter electrode(s). In FIG. 1 only one thin-film transistor (TFTs) 10 has been drawn, simply as an example.

FIG. 2 shows a voltage transmission curve of a liquid crystal device. It is know that in many kinds of LC effects the dielectric constant of the liquid crystal changes with the pixel voltage. So at voltage Vₜₕ, where in this case the transmission starts to decrease and has for instance reached a level of 90% a pixel has, under normal (untouched) circumstances, a capacitance Cₜₕ. Under the same circumstances at voltage Vₛₐₜ, where in this case transmission has for instance reached a level of 10% a pixel has, under normal (untouched) circumstances, a capacitance Cₛₐₜ. These values preferably are used as reference value to detect the measure of change after touching (depressing) of a pixel leading to a variation in the liquid crystal layer thickness. Similar voltage transmission curves are shown by display devices based on electrowetting and some display devices based on electrophoresis.

In general the pixel capacitance of one pixel is overshadowed by the capacitance of other pixels (in passive matrix), cross overs and stray capacitances (active matrix) in the columns and rows. This reduces the sensitivity.

One solution to this is to ensure that many pixels along the column 6 (or row 7) are sensed at the same moment. In this case, the touch signal will increase with the number of pixels being sensed, whilst the background capacitance will remain constant. In this way the signal to noise ratio will increase. In a preferred embodiment, the touch sensing procedure will involve many rows 7 being addressed at the same time (active matrix) or many columns 8 being connected to increase the touch signal.

In the embodiment of FIG. 3, a keypad, most pixels within a touch sensitive display part 11 are in a defined state (background pixels), such as white liquid crystal display pixels, which at (or below) their threshold voltage Vₜₕ have a known capacitance. In the example (passive LCD) keypad, only a few pixels are dark pixels, viz. the numbers themselves, and have higher capacitance whilst the majority are white background pixels. In particular, many rows 22 and columns 23 (those between the numbers) comprise entirely background pixels, and several blocks 24 of pixels between the numbers are attached to both rows and columns where no dark pixels are present.

In these devices these blocks of background pixels can be used for touch sensing, in which touch sensing is for instance performed during the blanking time between two frames. If, for instance, all rows driving pixels in the top quarter 12a of the display, drive sensing pixel blocks and the columns are used for direct sensing of the pixel capacitance, one is able to detect the charge flowing along the block of columns when the LC polarity of the sensing pixels in these columns is inverted (i.e. from—Vₜₕ to Vₜₕ). The normal charge during inversion would be
Qₙₒₘᵢₙₐₗ=2×Vₜₕ×Cₜₒₜₐₗ (1)
with Cₜₒₜₐₗ the capacitance of the block of sensing pixels in the top quarter of the display. In any block of sensing pixels where the capacitance is modified by touching the display (either pressure or stray capacitance) the capacitance will increase by C_{touch}.
Q_{touch}=2×Vₜₕ×(Cₜₒₜₐₗ+C_{touch}) (2)
By comparing this to the known Qₙₒₘᵢₙₐₗ value, one can determine whether the display has been touched in the top set of numbers e.g. by measuring the charging current, i.e. the difference in impedance (capacitance).

Subsequently, the three remaining blocks 12b, 12c, 12d of rows are activated and the touch sensing continues until the display is completely scanned.

A similar reasoning applies to active matrix LCDs, in which the charging current is flowing through the address TFTs.

During sensing, the dark pixels where data is present (i.e. the numbers on the keypad) are never addressed, and as such they will maintain their grey value (during the blanking period). In the example of FIG. 3 however, the groups of rows and columns to be used to provide the image may be completely separated from the groups of rows and columns to carry out the touch sensing. In this case it is possible to carry out the touch sensing operation during the frame period. For example, if the keyboard (or a menu) data were being presented in a low frame rate, low power mode (e.g. at 5 Hz or lower refresh rate) it is still possible to carry out touch sensing at a much higher frequency. This results in a more rapid touch response, with no delay due to waiting for the next blanking period between two frames. In this preferred embodiment, it is possible to incorporate several touch measurement periods within one frame time. The use of several touch measurement periods within one frame time improves the reliability of the system.

In more complicated displays (monitors, electronic games) it may be advantageous to be able to do the touch sensing while all or most of the display is active. This implies that lots of pixels are at different (and changing) voltages and hence have different capacitances. To be able to detect a reference value in such a device a similar approach is taken into account again, but a field memory is used. By signal processing the expected nominal capacitance of the sensing area is determined e.g. by summing the individual charges from each pixel.
Qₙₒₘᵢₙₐₗ=Σ(2×V_{lc}×Cₚᵢₓₑₗ) (3)
Now a look-up-table (or similar device) is used to determine Cₚᵢₓₑₗ at a given pixel voltage (temperature, frame time etc.). In any block of sensing pixels where the capacitance is modified by touching the display (either pressure or stray capacitance) the capacitance will increase by C_{touch} again, leading to
Q_{touch}=Σ(2×V_{lc}×(Cₚᵢₓₑₗ+C_{touch})) (4)
Again, the touch position can be determined by comparing the calculated nominal charge and measuring the charging current to the block of display pixels.

In general, one current amplifier will now be used to sense pixels simultaneously within a column where touch sensing is required, and that it will no longer be possible to probe many pixels simultaneously by addressing multiple rows.

In a further embodiment pixels (or block of pixels) with the same nominal capacitance (for example all pixels at the lowest pixel voltage Vₜₕ) and corresponding known capacitance are used as a reference. Touch sensing is now carried out using only these pixels and by comparing the measured pixel capacitance to the known, nominal value defined in equation (1). In this method however the touch position of touch sensing will change dynamically depending upon the image content.

As an alternative a reset is applied to drive pixels to a predefined capacitance before the touch sensor operation is carried out. Detection is then carried out with reference to the known nominal capacitance value, as described above, (using equations (1) and (2)). Especially in LCD-displays, where a pulsed backlight is applied (LCD TV's and other multi-media applications where video is shown) it is possible to carry out the reset function during the dark period between pulses and carry out touch sensing without distorting the image.

In yet another approach, a scanning reset function could be applied, to reset the pixel to a predefined capacitance and carry out the touch sensing measurement just before the pixel is re-addressed.

In LCD applications, a reset to high voltage (e.g. black) is preferred, as the LC response time is shorter at high voltages. This means that the LC will reach its final capacitance more quickly, and touch sensing can be carried out with a higher frame rate. In addition, the LC capacitance varies less above a certain voltage (capacitance/voltage curve is less steep at higher voltages), so any pixels which have not completely reached their reset capacitance will only result in small errors.

In a further embodiment dummy pixels within the display are only used for touch sensing and not for displaying information. These pixels then have a known capacitance and sensing can again be carried out as described above. Distortion of the image by the presence of these dedicated pixels will have minimal perceptual impact if these pixels are arranged, for example, at the edge of the display. On the other hand these pixels may be arranged in the form of blocks (or even as larger segments) and distributed around the display. The output of (several of) these sensors is then used to determine the position of the touch input.

In a modification of this embodiment these dedicated touch sensor pixels are arranged at regular spacings within the display. This however may lead to a noticeable pattern of (dark) pixels across the display. To avoid this, dynamic determination of said (blocks of) touch sensor pixels, by changing their position from one frame to another, will effectively prevent these pixels from being detected by the eye.

In a similar way the change in the stray capacitance between row lines and the counter electrode in an active matrix display (based on TFT-transistors as switching elements) can be used for detection of touching. This has the advantage that the stray capacitance between the row and the counter electrode is a fixed value, determined by the difference between the counter electrode voltage and the row (off) voltage and is not influenced by the pixel voltage.

FIG. 4 shows an output 7′ of a shiftregister 4, which is connected to a row select line 7 via a switch 13. The row select line 7 is also connected to a sensing circuit 14 which comprises a first input to a differential amplifier 15 having a resistor 16 between said input and its output. The other input is connected to ground in this example.

A change in Cₚᵢₓₑₗ will generate a change in Vₚ and the output in Vₓ at node 17 can be expressed as:

$${V}_{x} = - {R}_{1} {C}_{pixel} \frac{ⅆ Vp}{ⅆ t}$$

from C=Q/V, it follows,

$$\frac{ⅆ C}{ⅆ t} = - \frac{Q}{{V}^{2}} \frac{ⅆ V}{ⅆ t}$$

Hence, the expression for Vₓ can be written as

$${V}_{x} = {R}_{1} {V}_{p} \frac{ⅆ {C}_{pixel}}{ⅆ t}$$

which signal will increase when applying a force on the touch screen. If the output impedance of the row driver is high enough not to disturb this measurement switch 13 may be deleted. On the other hand, if necessary an extra switch 18 may be used, which is only closed for measuring during non-selection of the row 7 (switch 13 may be opened then).

Since a detection circuit as shown in FIG. 4 can be associated with any line (and/or column) continuous simultaneous touch detection of (blocks of) picture elements over the total display area is possible. This offers the possibility of the features in computer and telecommunication applications as mentioned in the introduction, like simultaneous detection of functions and selectively activating parts of a display screen.

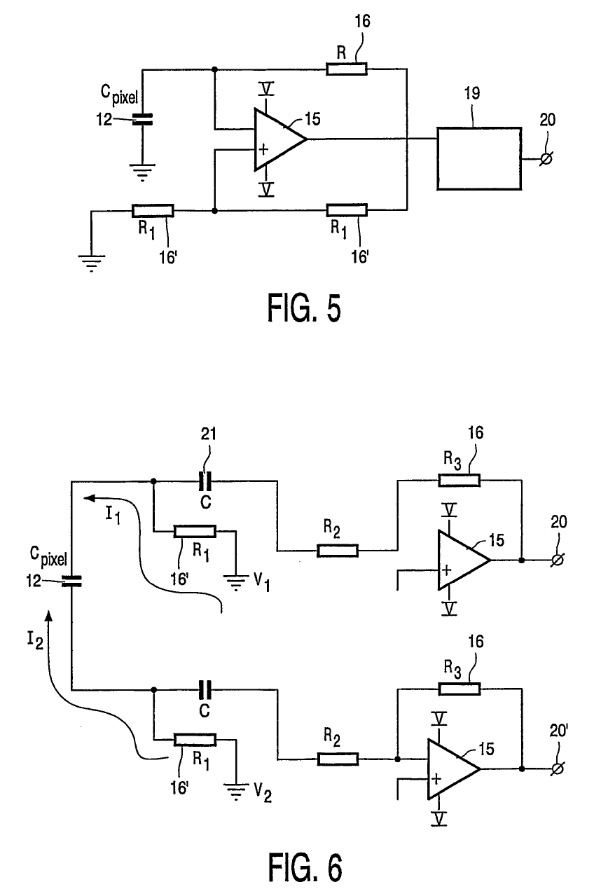

In the example of FIG. 5 the change in capacitance of a pixel (which may include a storage capacitance) is directly detected by measuring the oscillating frequency of the circuit, which is given by R×Cₚᵢₓₑₗ. To determine if the screen has been touched, it is sufficient to measure a shift in the oscillating frequency of the circuit comprising a amplifier 15 and resistors R, R₁ (16, 16′). Said shift is determined at output 20 by means of a frequency measurement device 19, using for example a filter to detect an increase in frequency.

FIG. 6 finally shows how the picture electrodes are incorporated in a typical microphone circuit. The pixel in its undisturbed state will have a voltage difference of (V₁−V₂) thereby having charges deposited on each side of the capacitor plate (the pixel). Perturbing the pixel by applying pressure will result in a change in its capacitance. This results in currents I₁ and I₂ flowing from both sides of the pixel electrode. The two said currents are equal in magnitude resulting into a similar voltage drop across the two R₁ resistors 16′ in the circuit. As the two amplifiers 15 only measure the voltage change in R₁ due to the blocking capacitor 21 (C), the circuit outputs 20, 20′ ideally provide the same voltage signal—that is,

$$[ ( {V}_{1} - {V}_{2} ) \frac{ⅆ {C}_{pixel}}{ⅆ t} ] {R}_{1} [ \frac{{R}_{3}}{{R}_{2}} ] .$$

Although the examples given so far have been related to liquid crystal display devices, in which the capacitive part of the impedance generally is influenced mainly by touch sensing, and mainly voltage measurement is described, similar reasoning applies to display devices, in which the resistive part of the impedance generally is influenced mainly by touch sensing, and detection methods based on current measurement are used.

So the protective scope of the invention is not limited to the embodiments described, while the invention is also applicable to other display devices, for example, (O) LED displays, electrophoretic displays, electrochromic displays, plasma displays, and other display devices based on e.g. field emission electrowetting etc.

Alternatively, flexible substrates (synthetic material) may be used (wearable displays, wearable electronics).

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A touch sensitive display device comprising a multiple of picture elements and means for driving at least one of said picture elements together with means for monitoring the impedance of at least one of said picture elements and substantially simultaneously sensing a change in said impedance.

2. A touch sensitive display device as claimed in claim 1 in which the means for sensing the change in said impedance measure a change in capacitance

3. A touch sensitive display device as claimed in claim 1 in which the means for sensing the change in said impedance measure impedances of different groups of picture elements substantially simultaneously.

4. A touch sensitive display device as claimed in claim 1 in which the means for sensing the change in said impedance measure a change in voltage.

5. A touch sensitive display device as claimed in claim 1 in which the means for sensing the change in said impedance measure a change in current.

6. A touch sensitive display device as claimed in claim 1 in which the means for sensing the change in said impedance measure a change in frequency.

7. A touch sensitive display device as claimed in claim 1 in which the means for monitoring the impedance monitor at least one row of picture elements.

8. A touch sensitive display device as claimed in claim 1 in which the means for monitoring the impedance monitor at least one column of picture elements.

9. A touch sensitive display device as claimed in claim 1 in which the means for monitoring the impedance monitor a block of picture elements.

10. A touch sensitive display device as claimed in claim 1 in which the means for monitoring the impedance comprise means for comparing the impedance of the picture elements with a reference value.

11. A touch sensitive display device as claimed in claim 10 in which the picture elements comprise liquid crystal picture elements and the reference value is determined by impedance values of said liquid crystal picture elements having voltages outside the transition region of the liquid crystal picture elements.

12. A touch sensitive display device as claimed in claim 10 in which the reference value is determined by impedance values of dummy liquid crystal picture elements.

13. A touch sensitive display device as claimed in claim 10 in which the means for comparing the impedances comprise means to determine the reference value.

14. A touch sensitive display device as claimed in claim 4 in which the means for measuring a change in voltage comprise at least one amplifier.

15. A touch sensitive display device as claimed in claim 4 in which the means for measuring a change in voltage comprise a microphone detection circuit.
